(19) United States
(12) Patent Application Publication
(10) Pub. No.: US 2011/0153398 A1
(43) Pub. Date: Jun. 23, 2011

(54) Device, Method and System for Facilitating a Transaction

(75) Inventors: Phin Tjhai, New South Wales (AU); Chris Lawrence, New South Wales (AU)

(73) Assignee: LID POWER PTY LIMITED, Roseville, New South Wales (AU)

(21) Appl. No.: 12/936,771

(22) PCT Filed: Apr. 7, 2009
(86) PCT No.: PCT/AU2009/000414

§ 371 Date: Dec. 10, 2010

(30) Foreign Application Priority Data
Apr. 7, 2008 (AU) 2008901666
Jul. 10, 2008 (AU) 2008903555

(51) Int. Cl. G06Q 30/00; B65D 51/24

(52) U.S. Cl. 705/14.14; 220/212

(57) ABSTRACT

The present invention relates to a device, method and system for facilitating a transaction. In particular, it relates to a drinks container lid on which is provided transaction data, such as a machine readable code. The transaction data may be entered into a mobile communications device, such as a mobile phone, by key entry or by scanning. It then may facilitate a transaction. In one embodiment, the transaction data is a program which causes the mobile device to communicate with a remote transaction processing system to implement a transaction.

### FIELD OF THE INVENTION

The present invention relates to a device, method and system for facilitating a transaction, and, particularly, but not exclusively to a device, method and system for facilitating a product purchase transaction, loyalty transaction or gaming transaction.

### BACKGROUND OF THE INVENTION

It has been proposed to facilitate carrying out of transactions, such as transactions for paying for products, using communications devices such as computers (e.g. payment over the Internet). It has recently been proposed to utilize mobile communications devices, such as mobile telephones, PDAs and the like, to facilitate transactions.

Computers, such as PCs, which have access to the Internet, may be used to pay merchants for products, utilizing credit card numbers or other account details of a user. Products may include any goods or services. Products may include a gaming product e.g. paying for gambling on line. Use of mobile communications devices are more difficult than the use of computers such as PCs. This is generally because it is more difficult to access information to enable a transaction. For example, access to the Internet via mobile devices is very slow and unpredictable. Further, the information that can be displayed on a mobile handset display is limited. Shopping “on line” is far more difficult via a mobile device, for example.

### SUMMARY OF THE INVENTION

In accordance with a first aspect, the present invention provides a device for facilitating a transaction, comprising a drinks container lid bearing transaction data arranged to be utilized to facilitate a transaction by a transaction processing system, the transaction data comprising matter readable by a processing device and loadable onto the processing device and comprising instructions for controlling the processing device to implement a transaction.

In the specification, the term “transaction data” is used broadly to mean “transaction information” and may comprise instructions such as a computer program for controlling the processing device. The transaction data may also include the data for the computer program, or the data for the computer program may not be included and may be provided elsewhere.

In an embodiment, the transaction data comprises a computer program which is arranged to be loaded on a computing device, such as a mobile telephone with a processor, to carry out a program operation.

The transaction data may be provided on the lid in the form of a code which can be scanned by a device such as a mobile processing device, such as a mobile telephone. The code may be QR code or similar codes that can provide information in the form of a computer program and/or computer program data to control operation of the computing device. The transaction data may also include data such as numbers which can be manually entered into a mobile device or scanned into a mobile device.

In an embodiment, the transaction data is in a form that can be entered into a processing device to cause the processing device to take action to implement the transaction. The transaction data may take the form of a program controlling operation of the processing device. The processing device may be a mobile communications device as discussed in relation to the above embodiments.

In an embodiment, the transaction data is in a form which is scannable by a processing device to be entered into the processing device. In an embodiment, the processing device is a mobile communications device as discussed above. In an embodiment, the data is a scannable form which can provide data for controlling the processing device to take action to implement the transaction. It may be a computer program, or instructions to call a computer program from a remote location (the called computer program controlling the transaction). In an embodiment, the transaction data may be embodied in a scannable code, such as QR code, or bar code, or any other code.

In an embodiment, the transaction data may be arranged to be transmitted to the transaction processing system via a communication system. In an embodiment, the communication system is a mobile communication system. The user who has purchased the drink, for example, may transmit the transaction data to the transaction processing system using a mobile communications device, such as a mobile telephone, PDA, laptop computer or other mobile communications device. The transaction data may comprise a communication systems identifier, such as a telephone number, for example, or Web page identifier, or other identifier. The transaction data may be transmitted via SMS, or any other communications protocol. All or some of the transaction data may be transmitted to the transaction processing system. Where the transaction data comprises a program, for example, the program may result in some data or information to be transmitted to the transaction processing system, or it may itself be transmitted to the transaction processing system. In an embodiment, transaction data may be transmitted to the transaction processing system and the transaction processing system may return a computer program to control a device such as a mobile telephone.

In an embodiment, the transaction is a gaming transaction. In an embodiment, the transaction data comprises a lottery code, enabling entry of a user into a lottery.

In an embodiment, the transaction may relate to purchase of a product, which may be goods or services. The transaction data may identify the product to the transaction processing system. In an embodiment, promotional material relating to the product may also be provided on the drinks container lid.

In an embodiment, the transaction may relate to payment of a bill. The bill may be for services or goods. Promotional material relating to the payee service/product may also be provided on the drinks container lid. Where the transaction data may include a program or data which may be read by a computing device such as a mobile telephone, the computing device may read the data (e.g. by scanning the lid) and the data may then cause promotional material to appear on a display of the computing device, or may obtain promotional material from the transaction processing system and to appear on the display of the computing device.

In an embodiment, the transaction is a loyalty system transaction. In an embodiment, the transaction data includes a loyalty product identifier, identifying a loyalty product to the transaction processing system. In an embodiment, the transaction processing system is arranged to credit a loyalty product account of the user.

In an embodiment, the transaction processing system may be arranged to identify a user account. The user account may be associated with a communications device identifier of the user, such as a mobile phone number, for example. In an embodiment, the transaction processing system may be arranged to debit the user account in accordance with the transaction.

In an embodiment, the transaction data may comprise a payee account identifier. The transaction processing system may be arranged to identify a payee account from the payee account identifier.

In an embodiment, the drinks container lid acts as a receipt for the transaction. In an embodiment, the drinks container lid may bear a receipt code. The receipt code may be unique to the lid.

It is an advantage of at least an embodiment of the invention that a user may undertake a transaction when they are in a relaxed frame of mind when they are drinking a drink they have just purchased, such as a takeaway coffee, for example. The transaction data is presented on the lid of the drinks containers so it is easy for the user to see. The transaction data may include promotional or advertising information relating to an associated product, competition, a bill paying service, etc. The user views this and undertakes a transaction using their mobile device. It should be noted that one issue with mobile devices is the media is being developed presently to deliver content to mobile devices, including advertising and promotion for products, games, etc. The problem with the delivery of such content is that it is a “push” model. That is, the media is downloaded to a user's mobile device. This can often be unattractive and irritating to a user. Providing promotion and transaction data on a drinks container lid, however, constitutes a “pull” model. The user only need engage in the transaction if they wish to, having viewed the information on the drinks container lid. This is an advantageous and extremely convenient tool for merchants etc to deliver a message to a user and at the same time have the user undertake a transaction using their mobile device. As discussed above, where the transaction data is in a form which can be entered into a processing device, such as a mobile telephone, the information may be viewed on a display of the processing device after it has been entered. Further, the processing device may be caused to take action to implement the transaction.

It is an advantage of at least an embodiment of the invention that it is a very good vehicle for “Call-to-Action” media campaigns. Call-to-Action media campaigns encourage a potential customer to take action immediately, when they are viewing the transaction data, for example. This is different from traditional marketing campaigns, such as poster and television advertising, which provide information to a consumer (which they may or may not view) and then hope that the consumer will take action based on that information. A Call-to-Action campaign invites a consumer to do something associated with the promotion there and then. For example, in embodiments of the present invention, the consumer, with their mobile telephone, is encouraged, by the transaction data on the lid, to take action immediately by, for example, scanning (or otherwise entering) the data into a mobile telephone, to initiate a software application, send SMS messages, access a website, email, ticketing, download, games and entertainment, gaming and lottery products and services purchasing, banking and financial services, payment, publishing and registrations. The transaction data on the lid on one hand and the mobile device on the other increases the likelihood of an action to be taken by the consumer because it is convenient and easy to use. Where the transaction data is in the form of a program or data or other information that can be entered into the mobile device, this eliminates the need for the consumer to manually enter the data, number and information required for the action. Where the data is automatically entered into the mobile device, such as scanning or other method of entry, for example, this facilitates accuracy and helps eliminate potential errors. For example, long and complicated website address or a full set of menu options for the consumer to select from, can be entered by scanning a code such as QR code or the like. A coffee or drink break means that a consumer is relaxed, comfortable, with time at hand to easily take the appropriate steps to utilize the transaction data and their mobile device. Having the lid as a receipt for a transaction also provides assurance to the consumer.

In accordance with a second aspect, the present invention provides a transaction processing system, comprising a processor arranged to implement a transaction utilizing transaction data from a device in accordance with a first aspect of the invention.

In an embodiment, the processor may be arranged to receive a user identifier and identify an account associated with the user, for use in the transaction. In an embodiment, the user identifier is an identifier of a mobile communication device associated with the user. It may be a mobile telephone number, for example. In an embodiment, the transaction processing system further comprises a database storing user account identifier data.

In an embodiment, the processor may be arranged to implement the transaction in accordance with instructions communicated between a processing device associated with the user and the processor. The processing device associated with the user may be a mobile communication device. The instructions may be provided from the transaction data via the mobile communications device, may be provided by the processor in response to the communications device, or may be provided in part by the processor and part by the communications device. In an embodiment, instructions may be in the form of a computer program. In an embodiment, the transaction data may comprise a computer program. In an embodiment, the transaction data may be in a form enterable into the mobile communications device of the user, and may be in a scannable form.

In accordance with a third aspect, the present invention provides a printed label arranged to be secured to a drinks container lid to provide a drinks container lid in accordance with the first aspect of the invention, the printed label bearing a transaction data.

In accordance with a fourth aspect, the present invention provides a system for facilitating a transaction, comprising a device in accordance with the first aspect of the invention, and a transaction processing system in accordance with the second aspect of the invention.

In accordance with a fifth aspect, the present invention provides a method of facilitating a transaction, comprising the steps of receiving transaction data which appears on a drinks container lid, and utilizing the transaction data to facilitate a transaction, the transaction data comprising instructions readable by a processing device to be loaded onto the processing device and to control a computing device to implement the transaction.

In accordance with a sixth aspect, the present invention provides a computer program comprising instructions for controlling a computer to implement a transaction processing system in accordance with the second aspect of the invention.

In accordance with a seventh aspect, the present invention provides a computer readable medium, providing a computer program in accordance with the sixth aspect of the invention.

In accordance with an eighth aspect, the present invention provides a computer program comprising instructions for controlling a computer to implement a transaction associated with a mobile communications device of a user and a device in accordance with a first aspect of the invention.

In accordance with a ninth aspect, the present invention provides a computer readable medium providing a computer program in accordance with the eighth aspect.

In an embodiment, the computer readable medium is a drinks container lid.

In accordance with a tenth aspect, the present invention provides a method of facilitating a transaction, comprising the steps of receiving transaction data which appears on a drinks container lid, being received by a mobile communication device, and utilizing the transaction data to facilitate a transaction, the transaction data being readable by the mobile communication device to be loaded on the mobile communication device to control the mobile communication device to implement the transaction.

This aspect of the invention may include any one or more of the features of any of the above aspects of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is an illustration of a device in accordance with an embodiment of the present invention;

FIG. 2 is an illustration of a device in accordance with a further embodiment of the present invention;

FIG. 3 is a schematic diagram of a system in accordance with an embodiment of the present invention;

FIG. 4 is a diagram illustrating application of an embodiment of the present invention in the purchase of a product;

FIG. 5 is a diagram illustrating operation of an embodiment of the present invention to implement a gaming transaction;

FIG. 6 is a diagram illustrating operation of an embodiment of the present invention to implement a bill paying transaction;

FIG. 7 is a perspective view from above and one side of a labeling apparatus for labeling a device in accordance with an embodiment of the present invention;

FIG. 8 is a view from one side of the labeling apparatus of FIG. 7;

FIGS. 9(a), (b), (c), are side views of a delivery apparatus for use with the labeling apparatus of the FIG. 7;

FIG. 10 is a perspective view from one side of a part of the delivery apparatus of FIG. 9;

FIG. 11 is a sectional view from one side of a stacker apparatus of the labeling apparatus of FIG. 7;

FIG. 12 is a perspective view from above and one side of the stacker apparatus of FIG. 11;

FIG. 13 is a perspective view from above and behind of the delivery apparatus of FIG. 9;

FIGS. 14(a), (b) and (c) are views from behind of the delivery apparatus of FIG. 9;

FIG. 15 is a plan view of a coffee lid utilized in accordance with an embodiment of the present invention;

FIG. 16 is a perspective view of the coffee lid of FIG. 15;

FIG. 17 is a view of a detail of the apparatus of FIG. 7, illustrating means for registration of container lids;

FIG. 18 is a perspective view from one side of the apparatus of FIG. 17;

FIG. 19 is a diagram illustrating a further embodiment of a device in accordance with the present invention and an application of the further embodiment;

FIGS. 20 to 23 are illustrations of devices in accordance with further embodiments of the present invention; and

FIG. 24 is a diagram illustrating operation of a further embodiment of the device in accordance with the present invention with a mobile communications device.

### DETAILED DESCRIPTION OF EMBODIMENTS

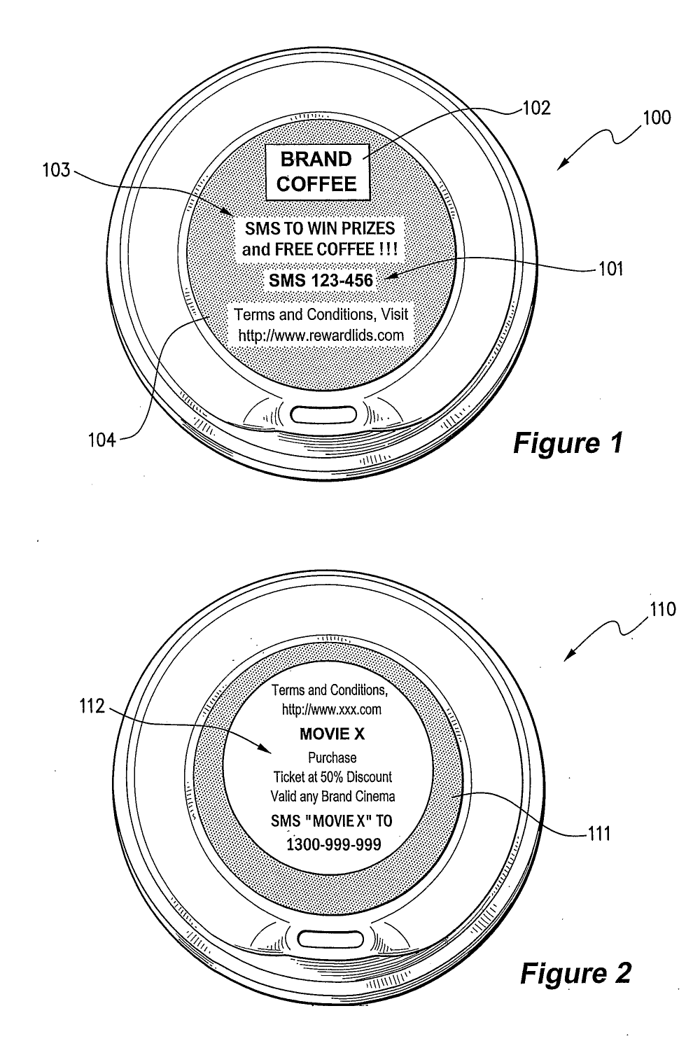

Referring to FIG. 1, there is illustrated a plan view of a drinks container lid, in this example being a takeaway coffee lid for a takeaway coffee container, which comprises a device for facilitating a transaction, in accordance with an embodiment of the present invention. The device is generally designated by reference numeral 100. The coffee lid 100 bears transaction data 101 for facilitating a transaction which the purchaser of the coffee may enter into. In this embodiment, the transaction data includes an SMS number which user can contact utilizing his mobile device. It may also include a unique code number (not shown) which can be communicated to the transaction processing system via SMS. The unique code number may be hidden under a removable sticker, referenced at 102. This example embodiment may be utilized to facilitate implementation of a loyalty system, as will be explained in more detail later.

The device 100 may also include branding and other promotional information 103.

In this embodiment, transaction data 101 is provided on a sticker 104 which is applied to the coffee cup lid 100. The invention is not limited to the transaction data being provided on a sticker. The transaction data may be directly provided on the lid e.g. by molding the lid accordingly, by printing the lid, or in any other manner. Application by sticker, particularly using a sticker application apparatus such as disclosed later on in this description, however, may be cheaper and quicker.

An advantage of providing transaction data and other promotional information in this way is that the consumer (user) will be presented with the information in a relaxed environment i.e. when they have just purchased a takeaway drink, such as a takeaway coffee.

The majority of consumers nowadays have mobile communications devices, such as PDAs or mobile telephones. The transaction data 101 may be transmitted to a transaction processing system via the mobile communication system associated with the user's mobile device. Conveniently, SMS may be utilized to transmit the information. Further, the transaction processing system may transmit replies to the user's mobile device utilizing the communication system.

Referring to FIG. 2, a further embodiment of the device in accordance with the present invention is shown. This device 110 is also a coffee lid. A sticker 111 on the coffee lid bears transaction data 112 relating to the purchase of a product, in this case purchase of a movie. Utilising this information, a user may communicate with the transaction processing system to facilitate purchase of movie tickets. It will be appreciated that any product may be marketed in this way and the invention is not limited to movie tickets.

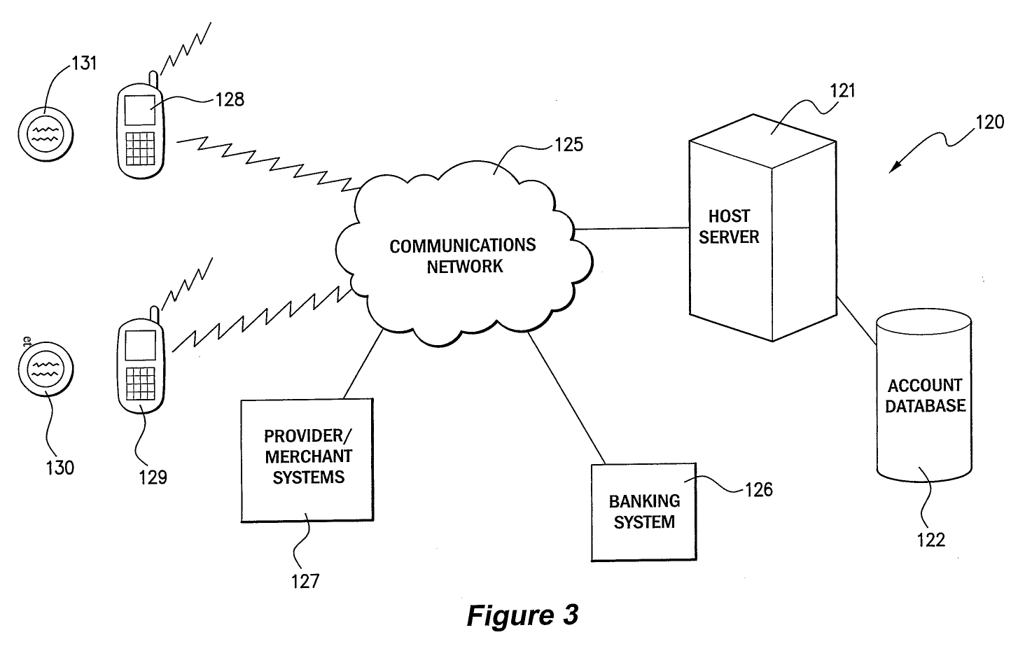

Referring to FIG. 3, a system in accordance with the present invention is illustrated. A transaction processing system 120 comprises a host server 121 and a database 122. It will be appreciated that the host server 121 and database 122 may be implemented by any appropriate arrangement of computer software and computer hardware. The invention is not limited to any particular architecture arrangement. The computer architecture may include a server/client architecture, a mainframe/terminal architecture, or any other type of computer architecture. Computer hardware will generally include a processor, memory, communications bus, user interface and any other hardware requirements.

The host server 121 receives, via a communications network 125 transaction data and any other communications information required to implement the transaction. The communications network may include any network or combination of networks, such as mobile telephone communications, Internet and any other network system. The network may enable communication of the host server 121 with other systems which may be required to implement the transaction such as a banking system 126 and provider/merchant systems (of which there may be many) 127. It will also be appreciated that there may be many banking systems 126.

In operation, the mobile device 128,129 (there may be any number of mobile devices depending upon the number of users) operated by a user may communicate transaction data from drinks container lid 130, 131 to the host server 121, in order to enable a transaction to be processed. Note that the host server may be operated by an independent operator, or by an owner of the communications network, or an owner of the banking system, or a provider/merchant system, or any other entity.

In the embodiments of FIG. 1 and FIG. 2, the transaction data is in a written form and it may be entered into the user's mobile communication device, such as a mobile telephone, by the user keying in the data. The data may be entered in other ways, such as scanning the data or taking a photograph of it. Many mobile devices nowadays include sufficient processing power such that they can include applications for reading data and entering it.

The transaction data may be provided on the device in any form.

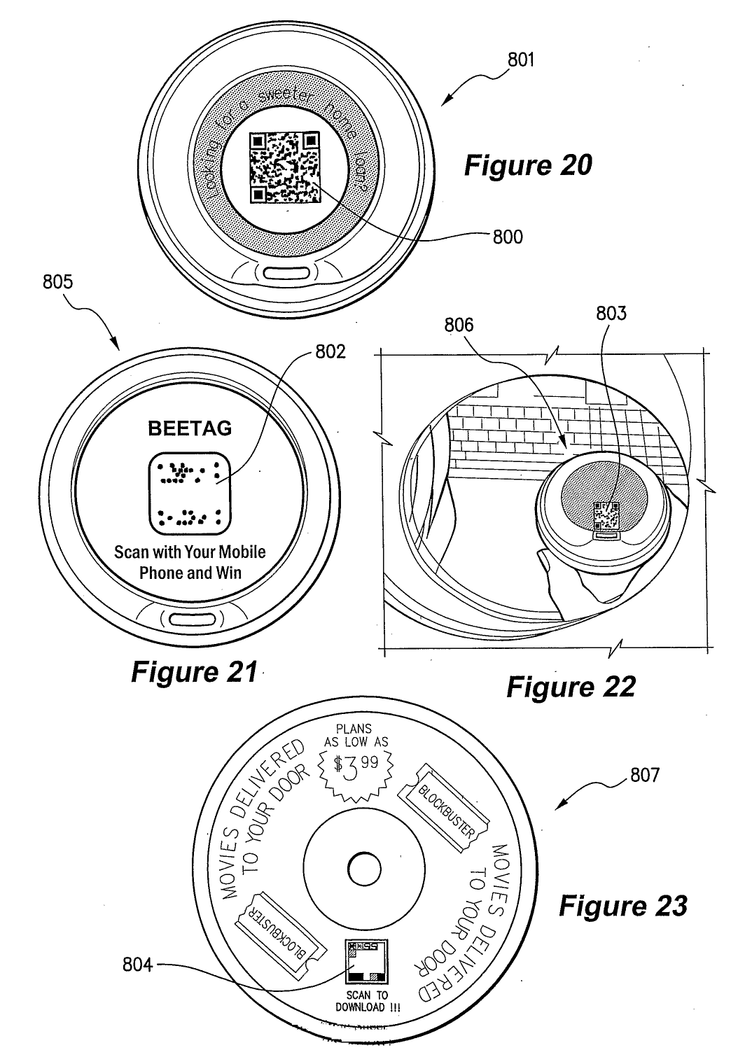

In other embodiments, the transaction data may be in coded form which can be scanned or otherwise entered into a mobile device. FIGS. 20, 21, 22 and 23 show different types of codes which can be scanned by a mobile telephone. FIG. 20 is QR code, for example, indicated by reference numeral 800 on lid 801. Other codes are referenced as 802, 803 and 804, respectively, on lids 805, 806 and 807. Any other types of codes may be used on the device in accordance with the present invention.

Codes such as shown in FIGS. 20 to 23, may contain transaction data comprising applications that can be loaded onto a mobile device (by scanning, for example) to control the mobile device to carry out tasks e.g. to carry out transactions, to produce displays (including menus for selection). The application may also call up another application from the transaction processing system to be downloaded to the mobile device, or interact with an application on the transaction processing system to facilitate transaction processing, or carry out any other task. The application can therefore interact with the mobile device to control a transaction.

This type of arrangement is particularly suited to a “Call-to-Action” type marketing approach. Because most consumers now have mobile devices with processing power, while relaxed and having a drink they can utilise the device of the present device by scanning the transaction data and undertaking the transaction. The device is a Call-to-Action to enter into the transaction.

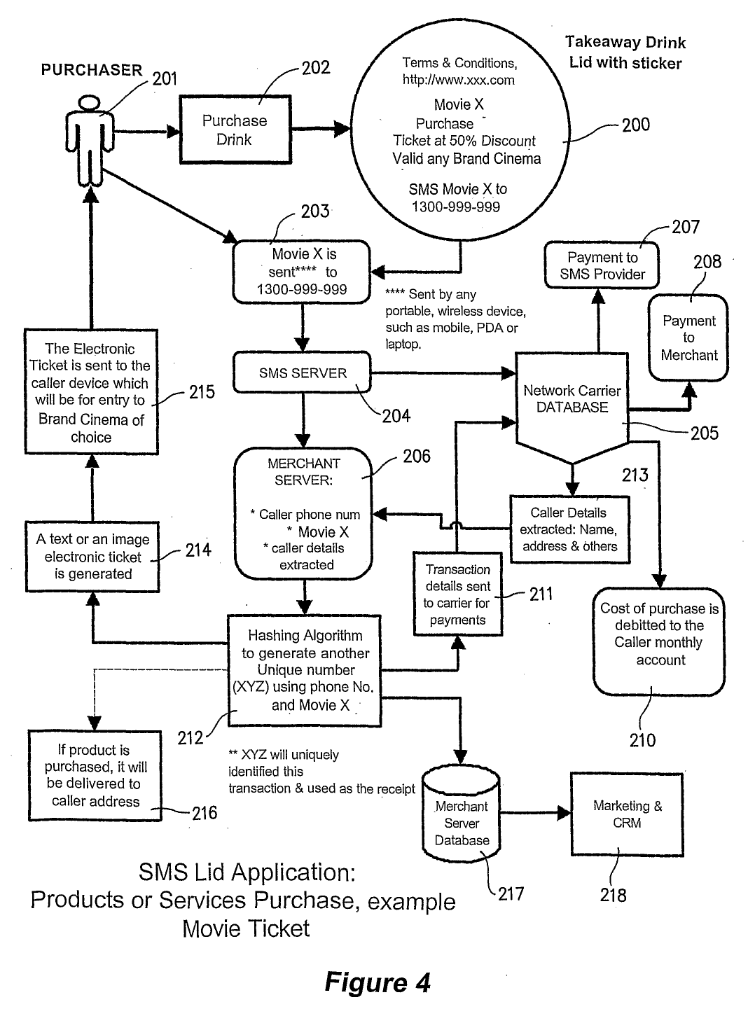

Some transaction processing examples will now be given with reference to FIGS. 4, 5 and 6. In the following examples, SMS communications is utilised and the devices of the type of FIG. 1 and FIG. 2 are used, where the transaction data appears in human readable script, which can be entered on the mobile device by the user. In alternative embodiments, codes which are scannable or otherwise enterable into the mobile device can be used to carry out the following examples (such as the code types shown in FIGS. 20 to 23).

Referring to FIG. 4, this illustrates a transaction process in accordance with an embodiment of the present invention, for purchasing products (note that products may include goods or services). In this embodiment an example is given of purchasing of movie tickets. The invention is not limited to movie tickets. Any product may be purchased utilising the device, system and process of this embodiment.

A drinks container lid 200 provides information and transaction data on a movie available for purchase. The drinks container lid is purchased by a user 201 when they purchase a drink 202. The user 201 decides they wish to purchase the movie ticket. Using their mobile telephone they SMS the number given on the drinks container lid 200 and the information on the movie (reference numeral 203). An SMS server 204 (communications network 125 of FIG. 3) advises the network carrier database 205 (host server 121 and account database 122 of FIG. 3). At the same time SMS server 204 sends a message to merchant server (the merchant providing the tickets) 206. The host server 121 deals with payment to the SMS provider for the messaging (207) and also deals with payment to the merchant 208. The cost of the payment is debited from a account which is associated with the purchaser 201. Because the host server 201 is aware of the user's telephone number (provided by the SMS server) it associates the telephone number with an account so it can identify which account to take payment from (reference numeral 210). In order to deal with payment, the merchant server provides transaction details (step 211) to the host server 121. The merchant server codifies the transaction information at step 212, for security purposes. The host 121 may extract caller details and provide these to the merchant for their use (step 213). The merchant server 206 (127 of FIG. 3) may generate an electronic ticket (step 214) and forward this to the purchaser's 201 mobile device (step 215).

Note that if the ticket is not an electronic type or another product is ordered which requires delivery, the product may be delivered to a delivery address provided by the purchaser via SMS (216).

An additional feature may be that the merchant may keep a database 217 for marketing and CRM purposes 218, populated by the information extracted during the transactions e.g. customer and purchase information.

The host server 121 may administer separate accounts for the purchaser's/user's 201 with the host system owner. Alternatively, an interface with the banking system 126 may be provided to use the users account at the bank.

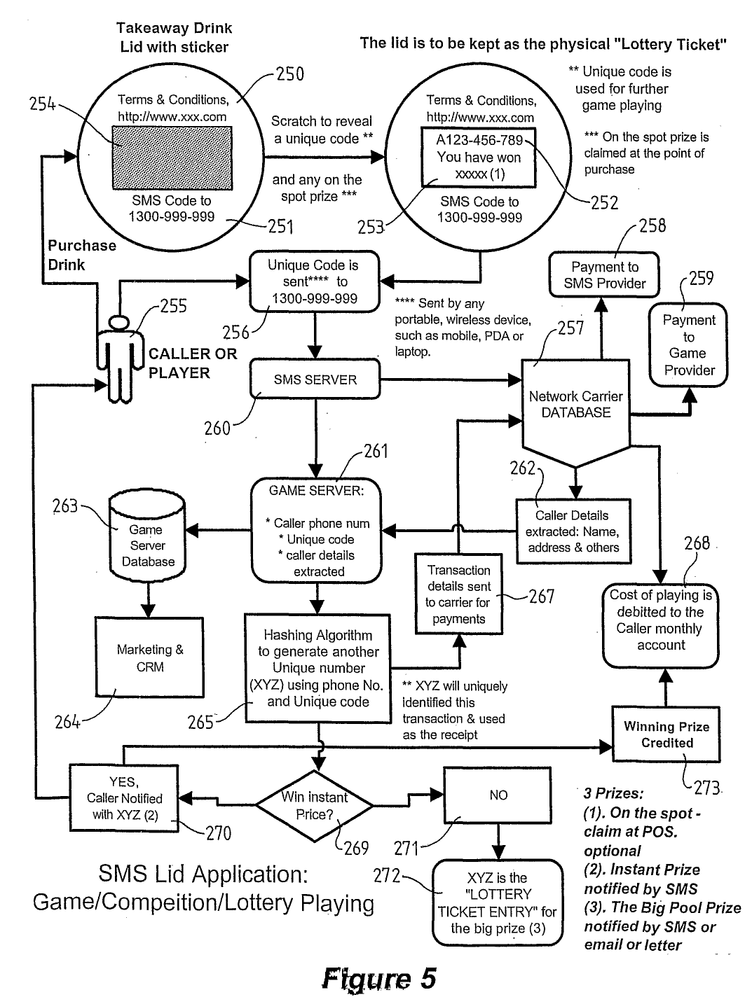

Referring to FIG. 5, a gaming transaction which may be implemented in accordance with this embodiment of the invention will now be described. A sticker 250 on a takeaway drinks container lid (e.g. coffee container) includes transaction data which includes an SMS number 251 and also a hidden code 252 and information on a prize 253. The code 252 and information on prize 253 are hidden under a sticker 254 which needs to be removed by the user 255. The code 252 enables entry in a lottery. The prize 253 is an “on the spot” prize that may be paid at the point of purchase. The code is sent to the SMS number (256). The SMS server advises the network carrier database 257 which deals with payment to the SMS provider (258) and payment to the game provider (259). This is done via SMS server 260. Caller details are provided to the game server 261 (step 262). The game server enters caller details with a unique code into a database 263 for marketing and CRM purposes (264). To implement security hashing algorithm is used (265) to generate a unique number using the caller's details and the unique code. These details are sent (267) to the host server so that the costs of playing the game can be debited to the user's account (268). A determination (269) is made as to whether an “instant prize” is won by the caller 255. If “Yes” (270) the caller is notified via SMS. If “No” (271) the unique code is entered into a lottery to be determined later (272). Note that an instant prize may be won and the lottery may also be entered.

In the above embodiment a player gets a chance to win an on the spot prize, an instant prize and a lottery prize. The invention is not limited to this. Any game may be played. It may be a simple lottery entry i.e. no on the spot prize and no instant prize or an instant prize or a simple on the spot prize. Note that if a player wins a prize it may be credited to their account (273).

The lid itself may be kept as a physical receipt i.e. operating as the “lottery ticket”.

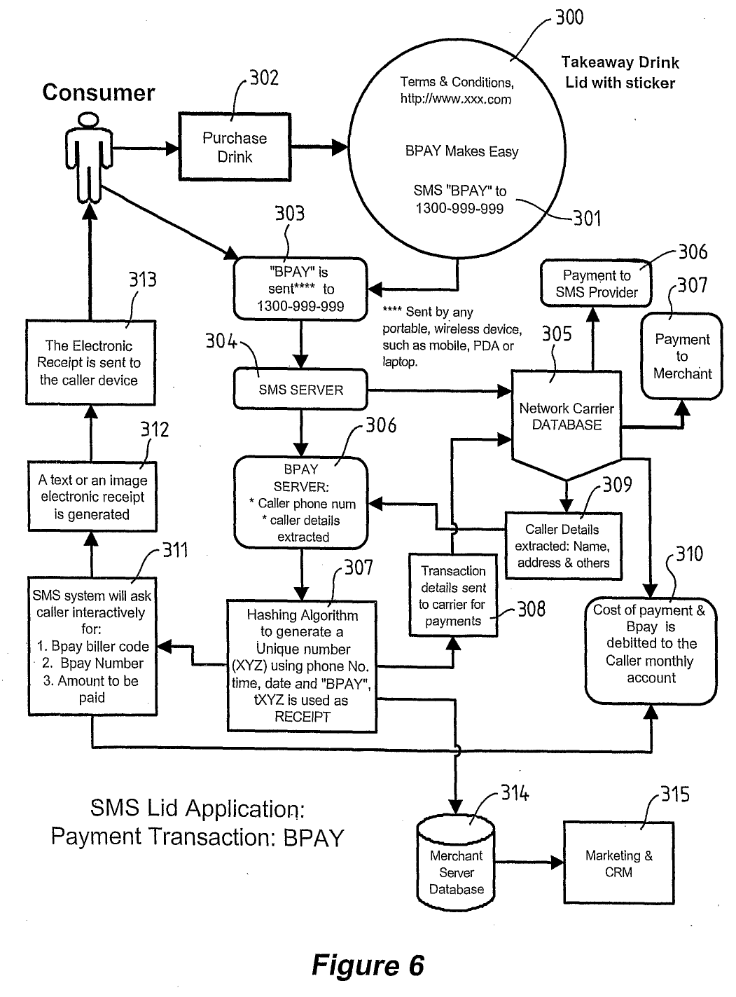

Referring to FIG. 6, an embodiment of the invention which facilitates a bill paying transaction will now be described. It is known to pay bills by using account details and paying over a network such as the Internet. Such bill payment systems are known as “Bpay” in Australia. In this embodiment, a service provider or product provider (e.g. a utility) may advertise their goods and services via a drinks container lid 300 and at the same time provide transaction data 301 to enable an SMS bill payment. The consumer purchases the drink at 302, reads the advertising and decides that they would like to pay their bill using the bill paying facility. The client SMS's the given number at 303 and the SMS server 304 forwards this onto the network carrier database 305 which deals with payment of the SMS provider (306) and also payment to the server's provider (307). Using the caller's phone number, details are extracted (306) and codified (307) and details are sent (308) to the network carrier 305. Note that the caller details may be extracted and returned to the Bpay merchant (309). The cost of the bill payment is debited from a user account (310). A receipt may be generated (311, 312, 313). A merchant server database 314 may extract details for marketing and CRM 315.

In another embodiment, the transaction processing system is arranged to implement a loyalty system. A code may be provided on a drinks container lid for implementing a reward system for the drink, for example. For example, loyalty to a particular brand of coffee may be implemented using a drinks container lid which may include promotional information on the coffee and a code relating to that purchase. After X products purchases (where X is a predetermined number) the user may be entitled to a free product e.g. a free coffee. The user SMS's the transaction processing system and advises them of the code number. The transaction processing system then determines a loyalty award (e.g. free coffee) and may even communicate with the retail outlet (e.g. coffee shop) to advise them. The user may also re register for prizes e.g. lottery prizes.

The above embodiments are only four examples of the types of transaction that may be undertaken using transaction data provided by a drinks container lid. Many other types of transactions are feasible. Also as discussed above, the transaction data may be provided in the form of code enterable to the mobile device of the user, such as barcode, QR code (or any other machine readable code). The transaction data may include a program for facilitating the transaction (i.e. controlling the mobile device to facilitate the transaction), or may call a program from the transaction processing system to facilitate the transaction. The mobile device may include a scanner or camera or other imaging device to read the code.

In the above embodiments, the drinks container lid is a lid of a coffee cup. The invention is not limited to coffee cup containers, drinks container lids for any drinks may be utilised for the present invention.

In some embodiments, as discussed above, the transaction data may be relatively complex and may provide control of the transaction process. For example, it may be part of a computer program or an entire computer program which can be entered into a processing device associated with the user (for example mobile communications device with the appropriate processing capability) to control part or all of the transaction. The transaction data could, additionally or alternatively, provide instructions to call up a program from a host system (such as discussed above) to control a transaction process. Complex transaction data may be provided by scannable codes which are provided on the drinks container lid, or codes which can be photographed or otherwise entered into the device. QR code, for example, can include large amounts of data, enough for a computer program or to call up a computer program from a host server. Other codes are available which can provide complex data as well and the invention is not limited to QR codes, or indeed scannable codes. The transaction data may be entered in other ways, such as RFID tags and the like and other technologies, by wireless, for example.

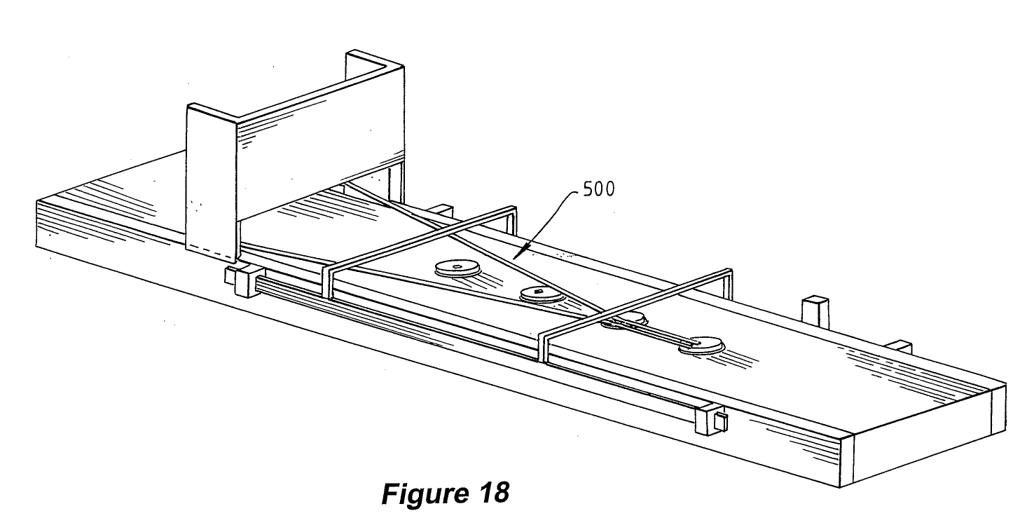

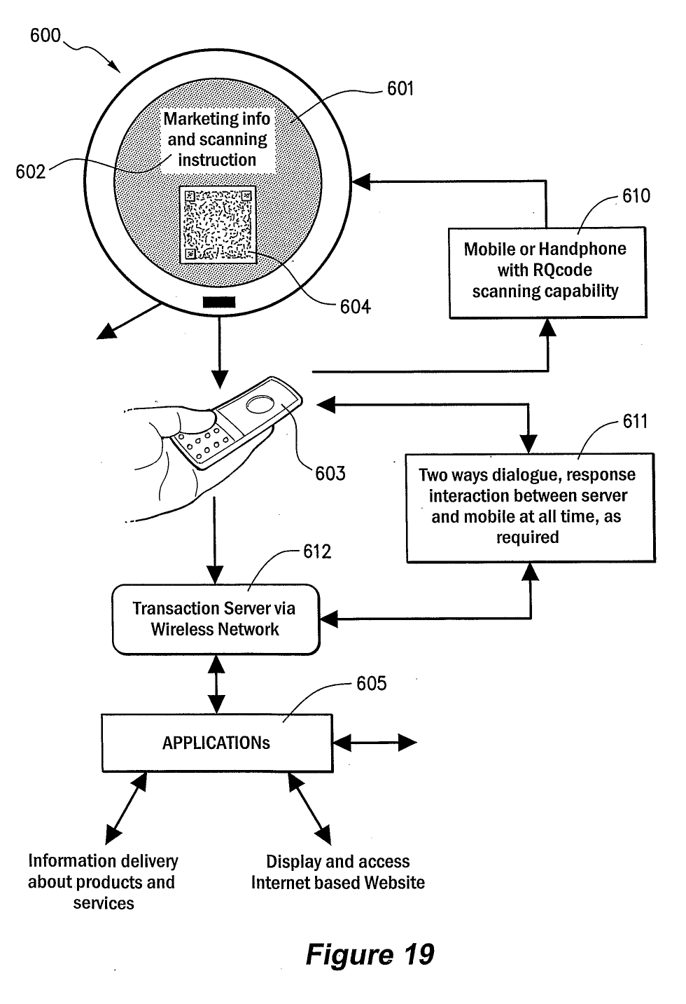

Referring to FIG. 19, a further embodiment which implements a relatively complex transaction process by way of providing a computer program on a drinks container lid or calling up a computer program from the host system will be described.

Reference numeral 600 designates a drinks container lid which includes a label 601 bearing marketing information 602 and an instruction to scan transaction data utilising a user mobile device 603. The user mobile device may be, in this embodiment, a mobile device 603 able to scan QR code.

The label 601 also bears a QR code 604 including transaction data. QR code is capable of handling large amounts of data in all types, such as numeric and alphabetic characters, or languages. Many characters can be encoded in a QR code 604. The QR code may encode a computer program, or instructions to fetch a computer program from a host server, for example. The transaction data may instruct a dialogue between the mobile communications device 603, user and an application 605 provided by a host system.

The mobile communications device 603 with QR code scanning capability scans the code (step 610). The code then controls the device 603 to implement a transaction between a host application 605 and the device 603 and user. The transaction may be a controlled two-way dialogue between the server and mobile, or as required (step 611). The communications system may be a wireless network 612 (in this embodiment) or any other communications network. Content may be downloaded from an application server, information, website information and information on services, products, gaming payment transactions, events, etc.

In an embodiment, rather than the code on the QR code 604 having been a program, it may be instructions to call a program from the application 605.

There are many applications which can be controlled in accordance with this embodiment of the invention. For example, the lid may advertise tickets to a new movie. Scanning the code into the mobile device results in a dialogue with the application server and download of a movie preview to the mobile device. The user views the preview and then has the choice of purchasing tickets (again controlled by the application).

The code, whether it be QR code or any other code, may be hidden underneath a label.

Combination of a code on the lid and a mobile user device can ensure that the transaction is facilitated securely.

1. Confidentiality—the code on the lid can be hidden and revealed by a number of ways e.g. scratching or peelable coupon. Nobody else can see the code except the person who has the lid in their possession.

2. Integrity—the code transmitted from the handset can be encrypted if necessary.

3. Authentication—the physical possession of the lid, plus the uniqueness of the code plus the uniqueness of the handset number and SIM card ID (in case of a mobile communications device).

4. Non repudiation—the physical possession of the lid, plus the uniqueness of the code plus the uniqueness of the handset number and SIM card ID.

All of these security factors ensure that in this embodiment the transaction is conducted under a “Trusted System” that may be certified by an agency such as Verisign™.

Particularly in embodiments where the transaction date is entered into the phone by scanning or wireless (but not limited to these embodiments), the data may be used to trigger an application on the phone (e.g. a program already residing on the phone), to facilitate subsequent transactions and/or as an output tool (such as a unique and secure receipt in the form of another code—such as QR code—which could be printed using a normal printer). Codes or data provided by scanning or wireless from the drinks container lid, which can provide plenty of data, can be used for many applications. Examples are as follows. It will be appreciated that the invention is not limited to the following example applications and there may be many other applications.
A merchant's “business card” that contains all the necessary data/information about the merchant, its product and services. Once scanned, the information is conveniently stored and available on the phone for later use. This illustrates that the application is not limited to financial transactions, but may also include transactions where information is provided. In this case the “transaction” is the detailed information about the merchant, his products and services, to be stored on the user's mobile communications device (potentially, in this example, for later use and financial transactions).
Subscription to services such as gymnasium, simply scan and pay (by liaising with a merchant server).
Digital Product purchase such as movie or theatre ticket, DVD, books, Songs, Videos, Airline ticket—simply scan, pay and download.
Merchant product and Product specials—scan to find out the latest products available and specials on offer from the nearest merchants near you as specified by your mobile GPS location—scan, select, pay and specified delivery.
Appointment with the dentist with one scan, the details of the dentist appears, select appointment time and confirm via SMS or another QR code.
Scan the QR code with the mobile. It will then automatically open the browser on your mobile and take you directly to the website embedded on the QR code for further interaction.
Gaming—the QR code is a unique lottery or lotto ticket. Scan to register to enter, pay. And play.
As QR code can contain textual information, it can be used to deliver critical and wide ranging government related information such as emergency services, timetable, social services, government regulations or compliance, safety campaigns, voting registration, etc.
Royalty or Reward program—simply scan to find out if you are an instant winner and register for the big prize.
Financial services—purchase financial product such as shares, insurance, term deposit, etc. Application on the mobile device works in conjunction with the QR code to enable secured and safe financial transactions such as payment and banking.
Consumer information—such as the fast food industry, the consumer can scan and find out more about the nutritional content in their food.

It will be appreciated that there may be many other applications.

As well as QR codes, any codes or RFID or any other way of entering information to a mobile device may be utilised in embodiments of the present invention. Examples of other codes include AZTEC code, Beetag, Colorcode, Datamatrix, EZ code, Microsoft™ barcode, shotcode and others.

Some advantages of devices in accordance with embodiments of the present invention include the following:
A one to one marketing environment
Relaxed and sociable
Uncluttered, free time for the customer
Maximum exposure
The drinks container lid has a good flat surface for scanning
Good scanning distance angle
Curiosity factor entices the customer to scan
Mobile devices are ubiquitous, those with scanners and web/wireless access will be ubiquitous
The mobile commerce may include products purchased, services purchased, digital contents purchased and delivery, lottery/gaming, payment transactions, event booking and purchases, and others.

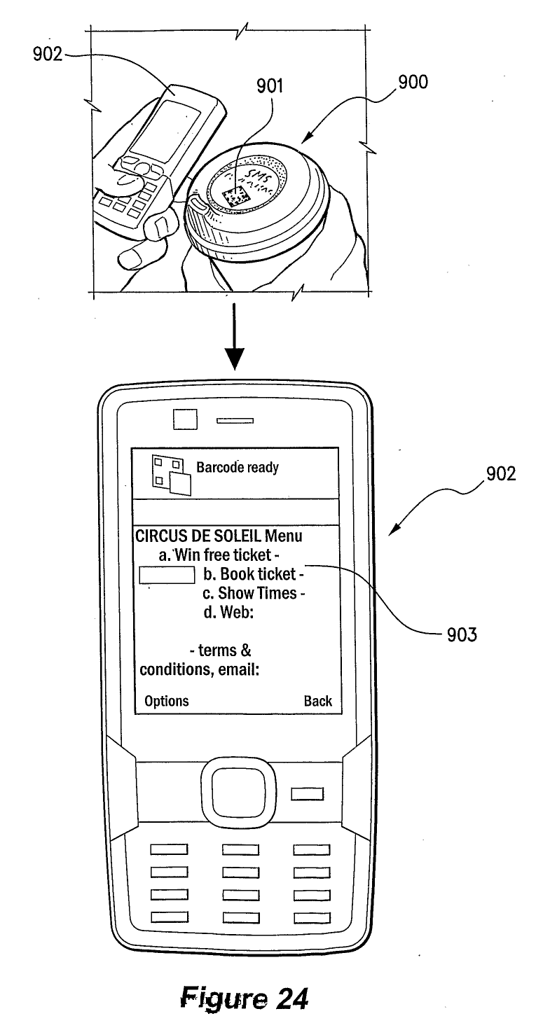

FIG. 24 illustrates ease of operation, where the user has a drinks container lid 900 while they are taking a drink, and they enter (e.g. by scanning a code 901) transaction data into their mobile device 902. In the embodiment illustrated a menu 903 appears for an application enabling a person to book a ticket for a show.

Note that, in the above embodiments, the transaction need not be a financial transaction. It can be any transaction of data between a host system and a user processing device, such as a mobile communications device, for example, facilitated by the drinks container lid device. It can be a transaction of information, for example, or any other data.

Note that information from transactions in the above embodiments may also be used to track where drinks purchases have been made, how many drinks purchases have been made, etc.

Note that the invention is not limited to mobile communications, although this is advantageous. Communications may be by any medium, including the Internet using personal computers etc.

Further, any communications service may be utilised, not only SMS.

The transaction is preferably some form of financial transaction, but not limited to this.

In the above embodiments, a printed label is applied to the lid carrying the transaction information. The printed label is preferably applied in “registration”, in the same orientation on each lid. For example, where the lid includes a spout, it would be useful if the information is orientated so that the person can read the label when they are bringing the spout to their mouth.

Embodiments of the present invention therefore comprise a plurality of devices in the form of drinks container lids which carry transaction information on a printed label which is orientated in registration with respect to the lid. In embodiments, a plurality of lids are provided with stickers having the same orientation. A labelling apparatus such as described in the following sections may be used to apply the sticker to the lid.

A labelling apparatus is generally designated by reference numeral 10. The labelling apparatus comprises a delivery apparatus 11 which is arranged to deliver drinks-cup lids 12 to a labelling station 13. It also comprises a stacker apparatus 14, which is arranged to receive labelled lids 12 and stack them in a convenient to handle stack 15.

In more detail, the delivery apparatus 11 delivers single lids 12 sequentially onto a conveyer 16 which is running in the direction shown by arrow A. The lids 12 move with the conveyer towards the labelling station 13 and are guided by a guide 17 to ensure that they are in the right location for labelling. The labelling station 13 comprises a labeller 18 which includes a roll 19 of printed labels to be affixed to the lids 12. The roll is mounted for rotation on an axle 20 and spindles 21, 22 guide a tape 23 mounting the printed labels from the roll to a delivery point 24. The labeller 18 is of known type. An infrared sensor 25 detects the position of the lid 12 and activates the labeller 18 to place a label on the3 drinks-cup lid 12. A sponge roller 26 is arranged to secure the label on the drinks-cup lid as the drinks-cup lid 12 passes under the roller 26.

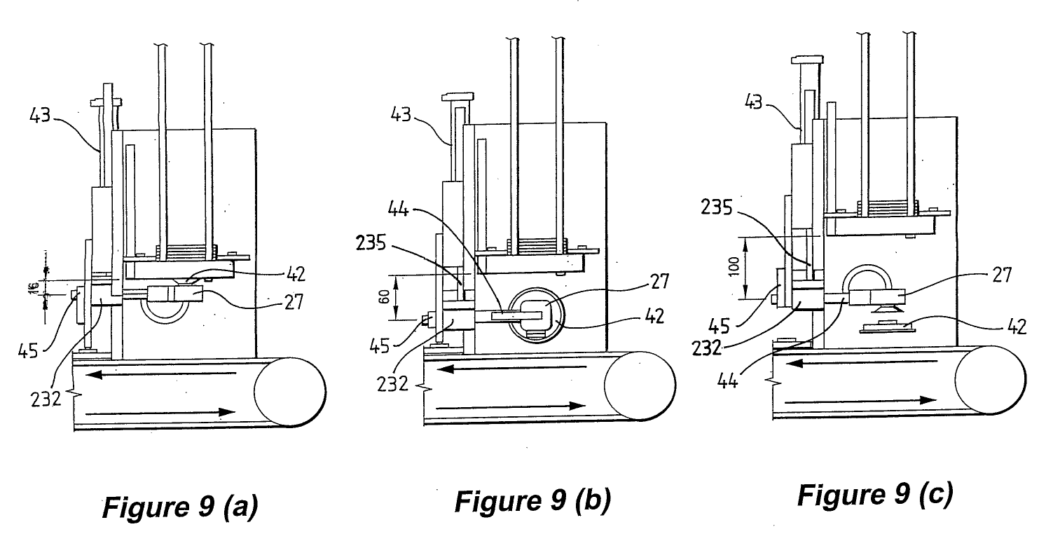

In order to ensure sufficient throughput with minimal manual intervention (and therefore low cost) single lids are placed on the conveyer 12 sequentially at intervals by, in this embodiment, a delivery apparatus 11 including a picker arrangement 27 which will now be described in more detail and in particular with reference to FIGS. 9(a), (b), (c) and 14(a), (b), (c).

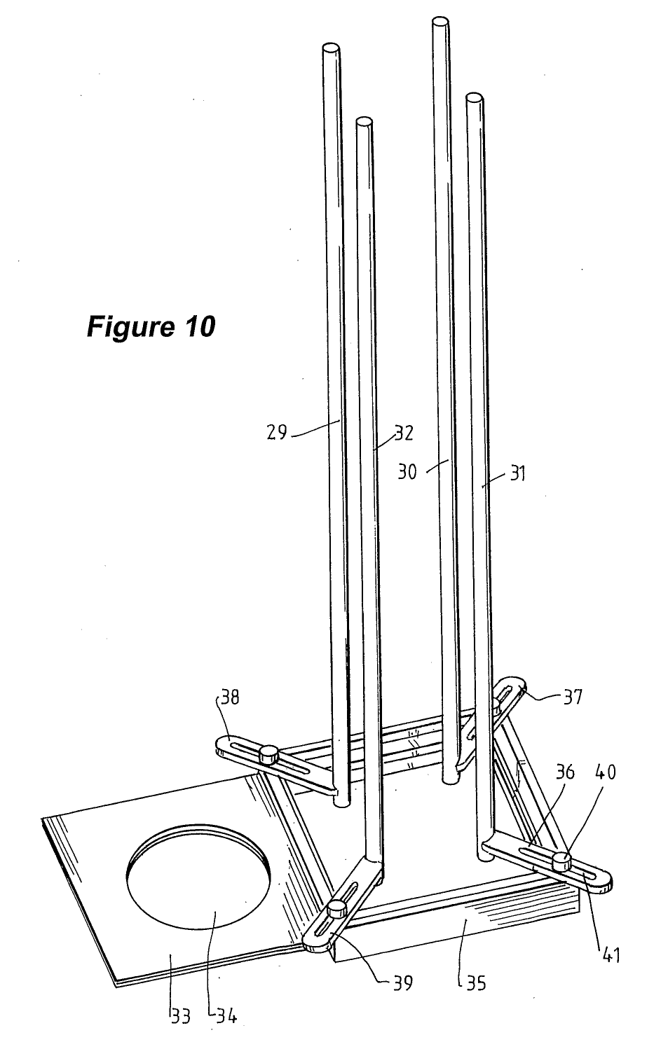

The delivery apparatus 11 includes a magazine 28, which in this embodiment includes four upstanding rods 29, 30, 31, 32, which are positioned to receive a stack of lids 12 for delivery to the labelling station 13. The lids 12 are fed by way of a dye 33 (FIG. 10), which defines a hole 34 corresponding to the size of the lids 12. It can be seen from FIG. 10 that the magazine comprises a frame 35 supporting the rods 29, 30, 31, 32. Note that in FIG. 10 the dye 33 is shown removed from the frame 35, and in use sits within the frame 35. Note also from FIG. 5 that the rods are mounted on adjustable mounts 36, 37, 38, 39 which are adjustable to enable the rods to be moved inwards or outwards to vary the size of the magazine to take different sized lids (similarly with the dye 33). The adjustable mounts 36, 37, 38, 39 work on a simple screw 40 and slide 41 arrangement in each case. Adjustment of the screw 40 relieves tension on the mount 36, 37, 38, 39 so that the screw 40 can move relative to the slide 41 to adjust the position of the rod.

Referring in particular to FIG. 9, the delivery apparatus 11 includes a picker arrangement 27. The picker arrangement 27 includes a grabber 42 which, in this example, is in the form of a suction cup. Powered by a compressed air driver 43 (linked to compressed air line, not shown), the suction cup 42 grabs a lid 12 from the magazine 28 (FIG. 9(a)) removes it from the magazine 28, and, rotating through 180° (FIG. 9(b)) places the lid 12 on the conveyer 16 and releases it (FIG. 9(c)). The picker arrangement 27 then repeats this operation and will continue until the lids 12 run out from the magazine 28 or the machine is switched off.

One of the problems with delivery of plastics and paper and other types of drinks container lids is that they are light, so that gravity feed to the conveyer is difficult if not impossible. They must be placed. Placing without manual intervention is difficult, and the picker arrangement 27 addresses this issue. The picker arrangement 27 includes a picker arm 44 which rotates to rotate the picker head 42 and moves downwards to place the lid 12 on to the conveyer. The picker arm is rotated by a cam arrangement 45, which enables the arm 44 and head 42 to be rotated quickly under the power of the compressed air driver 43. The picker arrangement can therefore operate rapidly and consistently to put in place drinks-cup lids 12 on the conveyer 16.

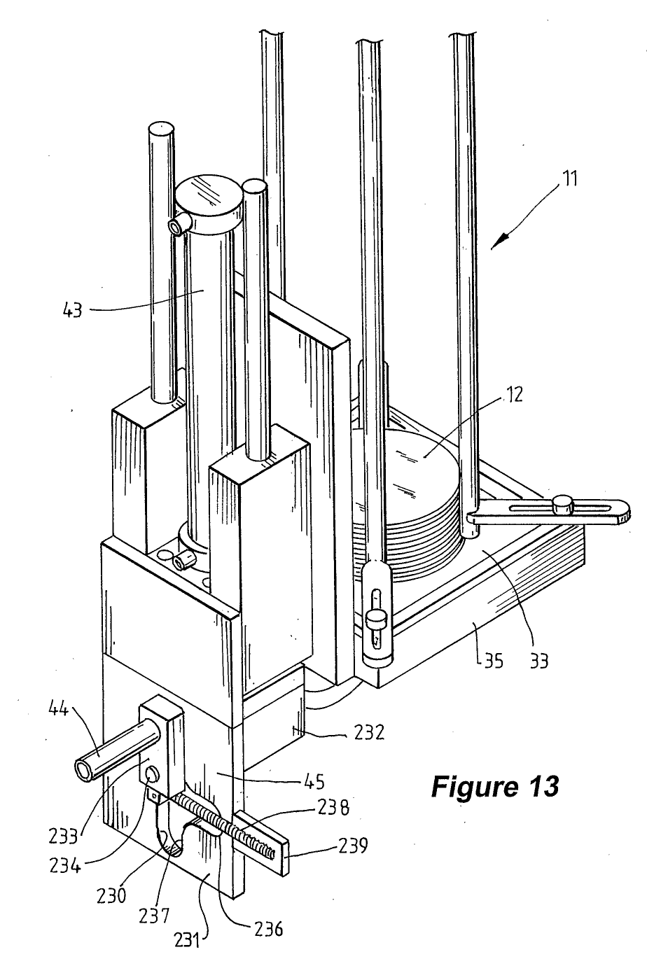

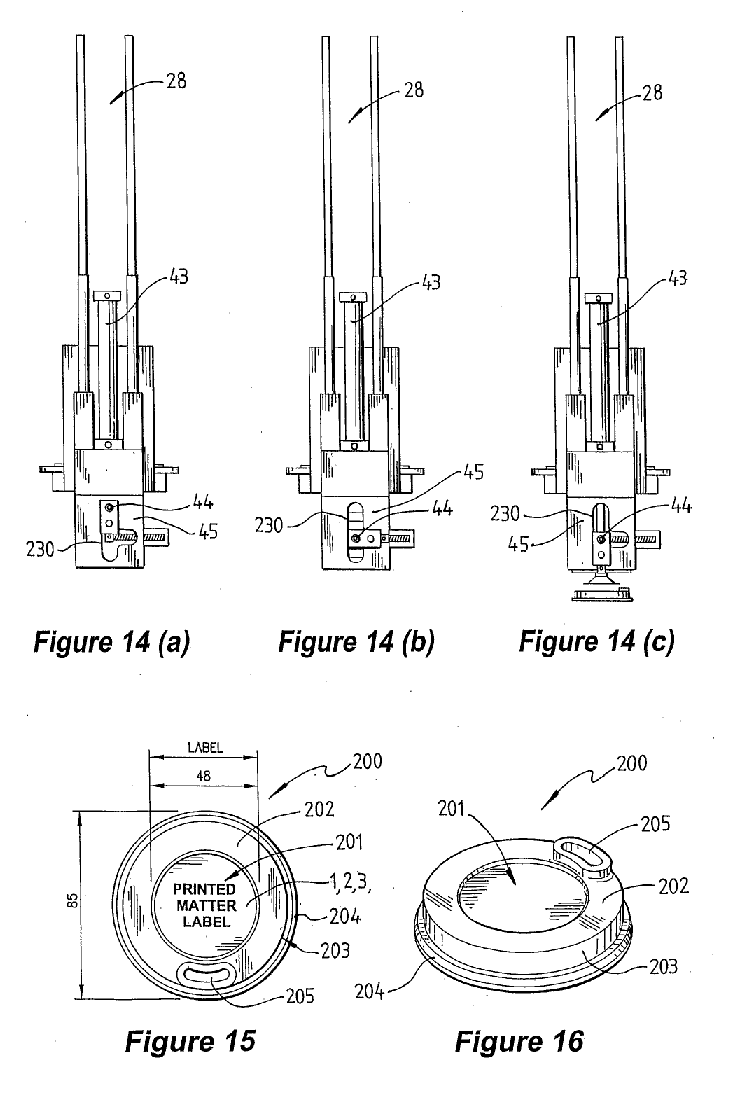

FIG. 14(a),(b),(c) show views which are of an operation of the cam arrangement. FIG. 13 also shows a detail illustration of the cam arrangement. The cam arrangement comprises a guide 230 in the form of a slot in a frame 231 at a back end of the delivery apparatus 11. The picker arm 44 is mounted for rotation within a movable mounting 232. The picker arm 44 extends through the mounting 232 out the back thereof and through a cam block 233. The cam block is mounted on a bearing 234 for movement within the guide 230. The picker arm 44 forms a hollow shaft through which compressed air can be provided to the grabber 42. A compressed air hose (not shown) is connected to the picker arm 44. A piston 235 is arranged to actuate the mounting 232 and move it downwardly in accordance with operation of the air driver 43. The movement downwardly of the movable mounting 232 also causes the picker arm 44 to move downwardly, removing the lid 12 from the magazine 28.

The guide 230 includes a horizontal section 236 half way down the longitudinal section 237 of the guide. A spring 238 is mounted with one end secured to a projecting portion 239 of the frame 231 and the other end secured to the bearing 234 or bottom surface of the cam block 233.

In operation, as the picker arm moves downwards, the bearing 234 at first remains in the longitudinal portion of the guide 237. When it reaches the horizontal portion of the guide 236, however, the spring 238 causes the bearing to move into the horizontal portion of the guide 236. The cam block therefore rotates through 90° (FIG. 14(b). On further motion downwards of the picker arm 44, the cam block 233 continues its rotation to 180° (FIG. 14(c). The picker head 42 is then in a position to place the lid 12 on the conveyer 16.

When the movable mounting 232 is moved upwards by the piston 235 in response to the air driver 43, motion of the cam block 233, picker arm 44 and picker head 27 is reversed.

Note that this cam arrangement is not the only arrangement which could impart the appropriate motion to the picker head. Other arrangements could potentially be used. For example, it may be possible to utilise a rack and pinion (the pinion being attached to rotate the picker arm 44) of appropriate size and dimensions.

Without such an arrangement, it is believed that the provision of drinks-cup lids with printed labels on them would be much more difficult and expensive. The picker arrangement 27 facilitates production of labelled lids 12 at such rates as to lower cost and make promotions using messages printed on the labels cost-effective.

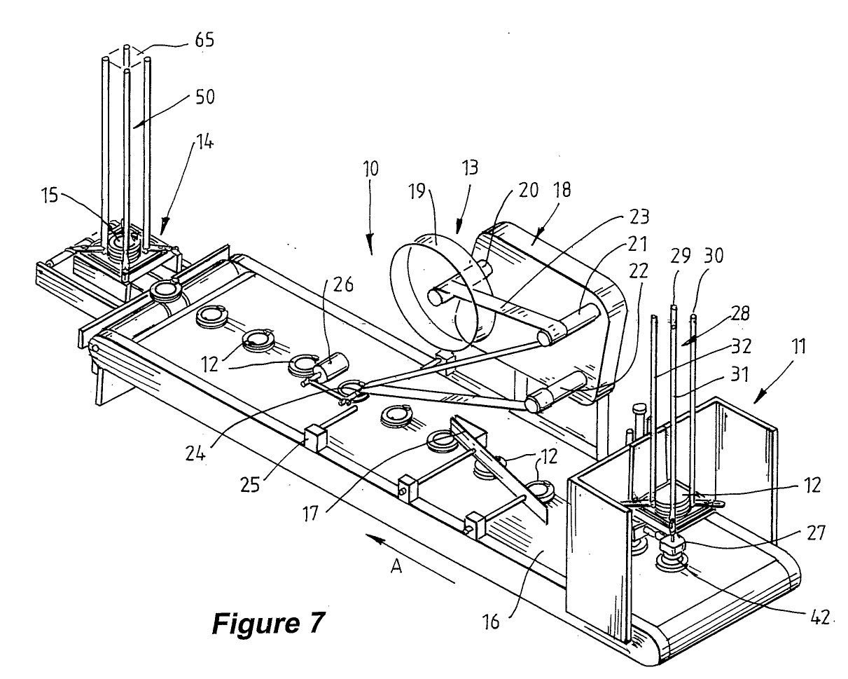

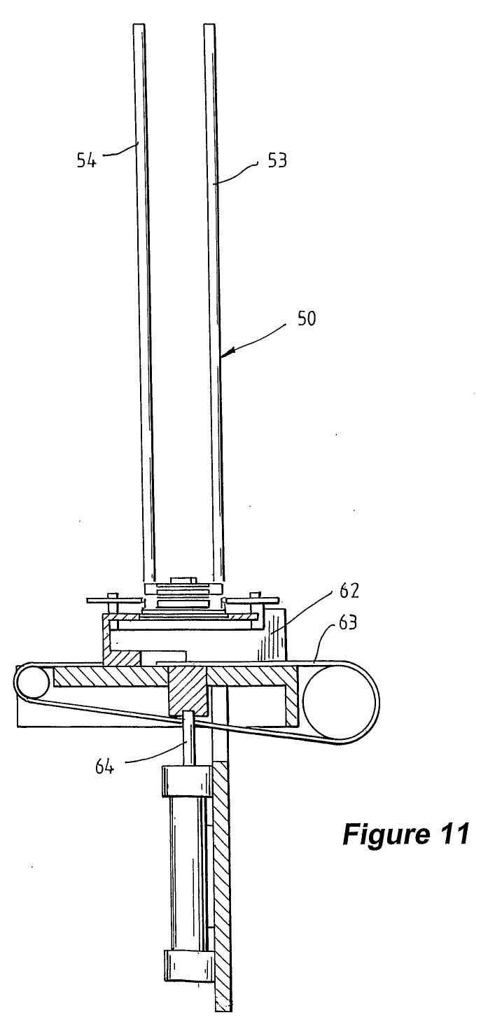

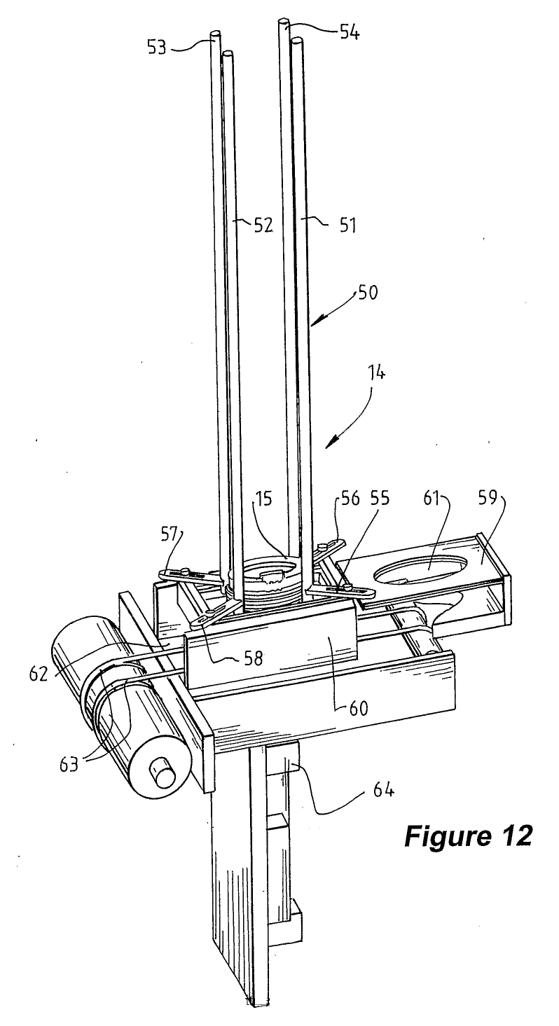

Referring again to FIG. 7, when the labelled lids 12 have passed the roller 26 they are conveyed by conveyer 16 to stacker apparatus 14. Referring to FIGS. 11 and 12 in particular, stacker apparatus 14 includes a magazine 50 which is similar in construction to the magazine 28 of the feeder apparatus 11. The magazine 50 includes four rods 51, 52, 53, 54, which are mounted on similar adjustable mounts 55, 56, 57, 58. The magazine 50 is thus adjustable in size so that it can receive drinks container lids of different dimensions. A template 59 sits within a frame 60 of the magazine and defines a hole 61 therein for receiving therethrough drinks container lids into the magazine 50. The template 59 can be removed and replaced with templates of different sizes (with different sized holes) for different sized drinks-container lids.

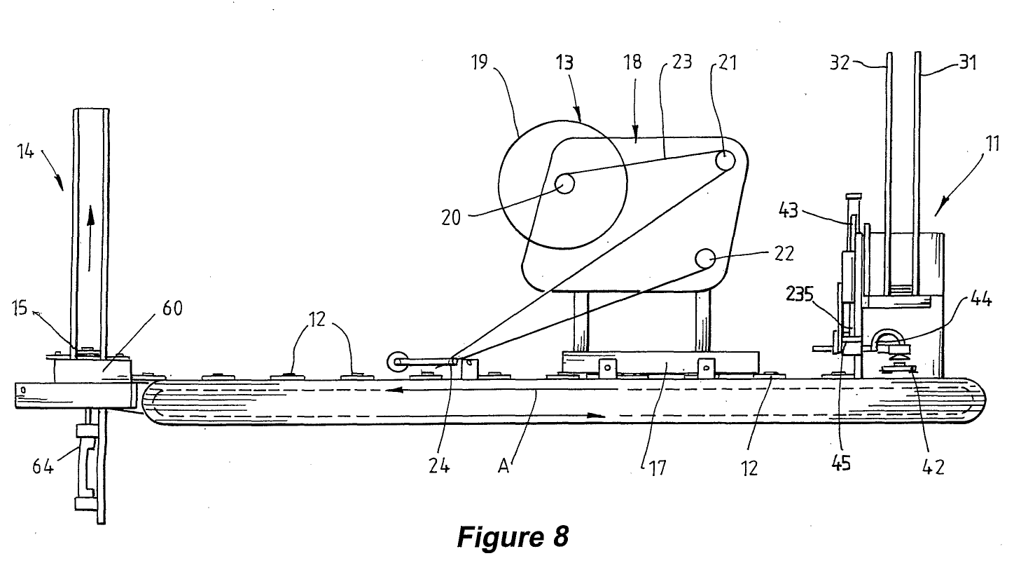

When lids 12 approach the stacker apparatus 14, they enter the stacker apparatus at a gate 62 defined by the frame 60. A further conveyer mechanism 63 conveys the lids 12 into the gate and to a position under the magazine 50. When a lid reaches the position as detected by an infrared sensor (not shown) an air driver 64, powered by compressed air) is activated to impel the lid 12 into the magazine 50. A stack 15 of lids 12 with printed labels is eventually built up in the magazine 50. Referring to FIGS. 7 and 8, a stack package 65 is supported by rods 51, 52, 53, 54. When the stack 15 is built up to the top of the rods, the stack package 65 and stack 15 can be removed as one for distribution to outlets.

At the delivery apparatus 11 more lids 12 can be placed in the magazine 28 before a previous load of lids is used. The apparatus can thus operate continuously to provide high productivity of lids with printed labels on them.

Because the placement of the lids on the conveyer 16 is automated it can be seen (see FIG. 2) that the lids are placed on the conveyer in the same orientation. In the example shown in FIG. 7, the “spout” of each lid 12 is directed towards the right side of a conveyer. This has the advantage that the printed labels are placed in the same orientation as each lid. Information presented by the labels can therefore be positioned with a predetermined orientation e.g. to ensure that the user is able to read the information.

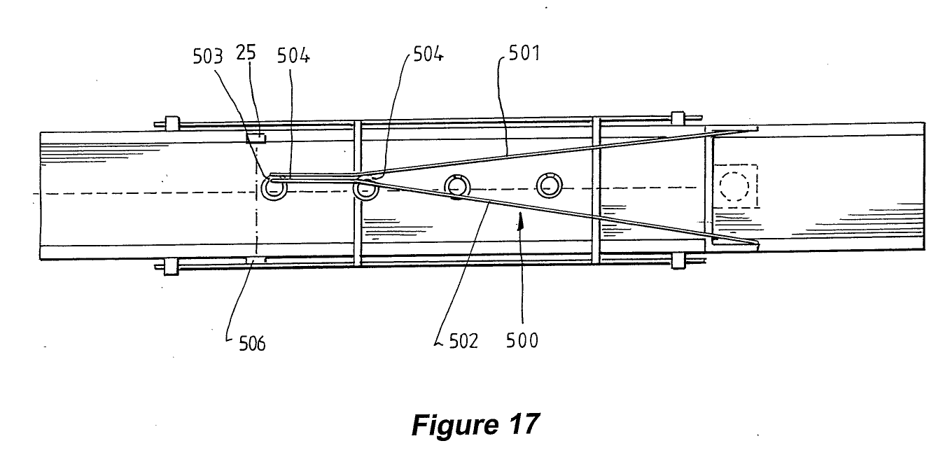

Further, in order to ensure that the same orientation is maintained for the label/lid combination, the speed of the conveyer 16 and tape 23 have to be synchronised so that lids arrive at the right time to be labelled. This is done utilising a stepper motor and appropriate software to minimise friction while placing the label on the lid (so as not to move the lid out of orientation). In addition, a registration device, indicated by reference numeral 500 in FIGS. 17 and 18 is used to facilitate consistent orientation of the drinks container lids so that when a label is placed on the drinks container lid, the label will be in the same respective orientation. In the preferred embodiment, the label is in an orientation such that any text is at “twelve o′clock” to the spout, as indicated in the example of FIG. 10. When a user is drinking from the spout, they will therefore be easily able to read any text on the label.

Referring to FIGS. 17 and 18, the registration device in this embodiment comprises a pair of rods 501, 502 which converge to a relatively narrow distance at the printing station 503. The rods serve to capture and guide a spout 504 of the drinks container lid so that the drinks container lid is always in the same orientation at the labelling station. Combined with the infra-red receiver 25 and transmitter 506, which activates labelling (the labelling head is activated when the lid breaks the beam), and combined with the synchronisation of the conveyer and tape, this facilitates labelling in the correct orientation.

Note that other registration devices may be utilised and the present invention is not limited to the registration device of the type 500.

The registration device 500 and infra-red receiver and transmitter arrangement also assist with ensuring that the label is placed in position in the central portion of the device. This is particularly important where the drinks lid is of the type having a raised rim and depressed central portion. It is difficult to ensure that the label is placed correctly. For example, it would be very difficult to do in a repetitive manual process. Having the transmitter and receiver arrangement and registration device facilitates positioning of the lid to receive the label.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-68. (canceled)

69. A device for facilitating a transaction, comprising:
a drinks container lid bearing transaction data arranged to be utilized to facilitate a transaction by a transaction processing system, the transaction data comprising matter readable by a processing device and loadable onto the processing device and comprising instructions for controlling the processing device to implement a transaction.

70. A device in accordance with claim 69, wherein the transaction data is arranged to be transmitted to the transaction processing system via a communication system.

71. A device in accordance with claim 70, wherein the communication system comprises a mobile communications device.

72. A device in accordance with claim 70, wherein the transaction data comprises a communication system identifier facilitating communications via the communications system.

73. A device in accordance with claim 69, wherein the transaction is a gaming transaction.

74. A device in accordance with claim 73, wherein the transaction data comprises a lottery code, facilitating entry into a lottery.

75. A device in accordance with claim 73, wherein the transaction data comprises a prize code indicating a prize to be awarded to a player.

76. A device in accordance with claim 75, wherein the prize is an “on the spot” prize.

77. A device in accordance with claim 69, wherein the transaction is purchase of a product.

78. A device in accordance with claim 77, wherein the transaction data comprises product identification data, arranged to identify the product to the processing system.

79. A device in accordance with claim 77, the drinks container lid further bearing advertising relating to the product.

80. A device in accordance with claim 69, wherein the drinks container lid is the type of lid arranged to fit to the mouth of a cup-type container.

81. A device in accordance with claim 80, wherein the drinks container lid is for a takeaway coffee container.

82. A device in accordance with claim 69, wherein the transaction data is in the form of a computer program arranged to control operation of the processing device.

83. A device in accordance with claim 69, wherein the transaction data is in the form which is scannable for entry into a processing device.

84. A device in accordance with claim 83, wherein the transaction data is in the form of QR code.

85. A transaction processing system, comprising a processor arranged to implement a transaction utilizing transaction data from a device in accordance with claim 69.

86. A transaction processing system in accordance with claim 85, the processor being arranged to implement the transaction in accordance with instructions communicated between a processing device associated with the user and the processor.

87. A transaction processing system in accordance with claim 86, wherein the instructions are in the form of a computer program.

88. A transaction processing system in accordance with claims 87, wherein the instructions are arranged to call into operation a program provided by the transaction processing system.

89. A method of facilitating a transaction, comprising:
receiving transaction data which appears on a drinks container lid, being received by a mobile communication device, and
utilizing the transaction data to facilitate a transaction, the transaction data being readable by the mobile communication device to be loaded on the mobile communication device to control the mobile communication device to implement the transaction.

90. A method in accordance with claim 89, wherein the transaction data includes computer program instructions for controlling the mobile communication device.
